(19) United States
(12) Patent Application Publication
(10) Pub. No.: US 2020/0026130 A1
(43) Pub. Date: Jan. 23, 2020

(54) METHOD OF PRODUCING GLASS SUBSTRATE FOR LIQUID CRYSTAL DISPLAY DEVICE

(71) Applicant: Sharp Kabushiki Kaisha, Sakai City (JP)

(72) Inventors: Akio OKAMOTO, Sakai City (JP); Kohshiroh TANIIKE, Sakai City (JP)

(21) Appl. No.: 16/513,850

(22) Filed: Jul. 17, 2019

Related U.S. Application Data
(60) Provisional application No. 62/700,362, filed on Jul. 19, 2018.

(51) Int. Cl. G02F 1/1337

(52) U.S. Cl. CPC G02F 1/133784; G02F 2001/1316; G02F 1/133723

(57) ABSTRACT

A method of producing a glass substrate for a liquid crystal display device includes a cleaning process of cleaning a substrate after performing a rubbing treatment on the substrate to align liquid crystal molecules. In the cleaning process, a position of a first cleaning material supply unit that supplies water-based cleaning material to the substrate on which a film of pretreatment material is disposed and that is transferred in a transferring direction is adjusted according to a film forming amount of the pretreatment material disposed on the substrate and transfer speed of the substrate.

### CROSS REFERENCE TO RELATED APPLICATION

This application claims priority from U.S. Provisional Application No. 62/700,362 filed on Jul. 19, 2018. The entire contents of the priority application are incorporated herein by reference.

### TECHNICAL FIELD

The present technology described herein relates to a method of producing a glass substrate for a liquid crystal display device including a cleaning process of performing a cleaning treatment for a substrate after performing a rubbing treatment for the substrate for aligning liquid crystal molecules.

### BACKGROUND

In producing a liquid crystal panel that is a main component of a liquid crystal display device, a surface of a glass substrate for a liquid crystal display device is coated with a polymer film (an alignment film) such as a polyimide film and an alignment treatment such as a rubbing treatment or a polarized ultraviolet ray irradiation treatment is performed to provide the alignment film with anisotropy in a certain direction. In the rubbing treatment, minute dust or shavings is created by rubbing the surface of the alignment film in the certain direction with a rotating rubbing roller. Therefore, the surface of the substrate is cleaned with pure water to remove foreign obstacles adhering to the surface of the substrate after the rubbing treatment.

A conventional example of the cleaning process of cleaning the glass substrate for a liquid crystal display device after the rubbing treatment described in Japanese Unexamined Patent Application Publication No. 9-33927 has been known. The cleaning process of cleaning the glass substrate for a liquid crystal display device includes a film forming treatment as a pretreatment before the cleaning. In the film forming treatment, a film is formed on the surface of the substrate with isopropyl alcohol (IPA) having a hydrophilic property to restrict cleaning unevenness on the surface of the substrate that may be caused in the subsequent cleaning process with pure water. Specifically, a film of IPA (pretreatment material) is formed on the surface of the substrate first and IPA is replaced with pure water in a subsequent process so that the surface of the substrate is covered with pure water in a uniform manner and the cleaning unevenness that may be caused in the cleaning with pure water is less likely to be caused. It is assumed that the cleaning unevenness is reduced because it is less likely to occur that IPA is replaced with pure water in subsequent processes and moisture remains locally on the surface of the alignment film and partial hydrolysis is undergone.

IPA has a low boiling point and high volatility. On the other hand, since a glass substrate for a liquid crystal display device has been increased in size recently, it takes longer time for a glass substrate for a liquid crystal display device including the IPA thin film to reach a next replacement tank compared to a prior art. Therefore, in the IPA thin film that has been previously formed, a front section of the IPA thin film in a transferring direction may start to disappear. Such unevenness of forming of the film may cause cleaning unevenness and this may increase a generation rate of foreign obstacle failures.

### SUMMARY

The present technology described herein was made in view of the above circumstances. An object is to suppress cleaning unevenness of a substrate in a cleaning process of cleaning a glass substrate for a liquid crystal display device after a rubbing treatment.

The present technology described herein is related to a method of producing a glass substrate for a liquid crystal display device including a cleaning process of cleaning a substrate after performing a rubbing treatment on the substrate to align liquid crystal molecules. In the cleaning process, a position of a first cleaning material supply unit that supplies water-based cleaning material to the substrate on which a film of pretreatment material is disposed and that is transferred in a transferring direction is adjusted according to a film forming amount of the pretreatment material disposed on the substrate and transfer speed of the substrate.

Time taken until a film of IPA (one example of pretreatment material) disposed on the substrate is volatilized and locally disappears and film forming unevenness occurs depends on a film forming amount of IPA disposed on the surface of the substrate and the transfer speed. Therefore, the position of the first cleaning material supply unit is adjusted according to them such that water-based cleaning material can be supplied before the occurrence of film forming unevenness. Accordingly, the IPA film forming unevenness is less likely to occur and the surface of the substrate is covered with the water-based cleaning material uniformly. Therefore, cleaning unevenness is less likely to be caused.

According to the present technology described herein, in the cleaning treatment of cleaning a glass substrate for a liquid crystal display device after the rubbing treatment, cleaning unevenness of the substrate is less likely to be caused.

### BRIEF DESCRIPTION OF THE DRAWINGS

FIG. 1 is a side view of a processing device of processing a glass substrate for a liquid crystal display device according to a first embodiment of the present technology.

FIG. 2 is a perspective view illustrating a film forming treatment where a film of IPA is formed on a substrate in a film forming tank.

FIG. 3 is a perspective view illustrating a process of supplying pure water to the substrate with a waterfall shower in a replacement tank.

FIG. 4 is a side view of FIG. 3.

FIG. 5 is a table illustrating time that is taken until film forming unevenness occurs with respect to an IPA film forming amount.

FIG. 6 is a graph relating data in Table of FIG. 5.

FIG. 7 is Table 1 illustrating experimental results of Comparative Experiment 1.

### DETAILED DESCRIPTION

### First Embodiment

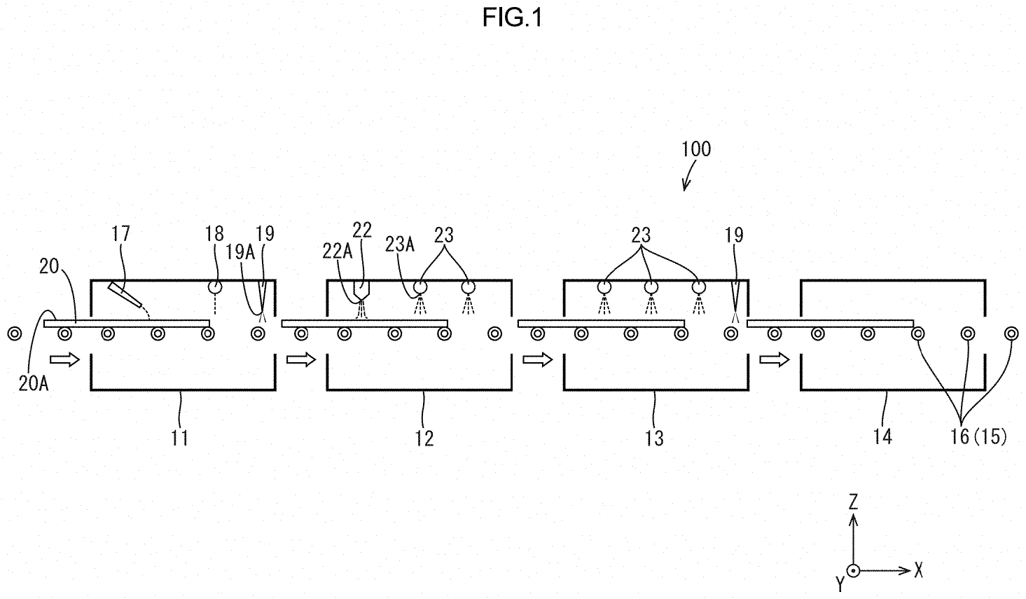

A first embodiment of the present technology will be described with reference to FIGS. 1 to 4. In this embodiment, a cleaning process performed with using a processing device 100 of processing a glass substrate for a liquid crystal display device for performing a cleaning treatment for the substrate will be described. In the following description, an X-axis direction in FIG. 1 is defined as a transferring direction of a substrate 20, a Y-axis direction that is perpendicular to a paper surface is defined as a right-left direction, and a Z-axis direction is defined as a vertical direction. In each of the drawings, a left side is an upstream side in the transferring direction and a right side is a downstream side in the transferring direction.

In the method of producing a glass substrate for a liquid crystal display device, the processing device 100 of processing a glass substrate for a liquid crystal display device is used in a cleaning process for cleaning the substrate after a rubbing treatment that is performed for the substrate for aligning liquid crystal molecules. Specifically, foreign obstacles such as minute dust or shavings adhering on a surface of the substrate 20 are cleaned in the cleaning process. The alignment film coated on the surface of the substrate is subjected to the alignment treatment (the rubbing treatment) with the rubbing method and accordingly, the foreign obstacles are generated and adhere on the substrate 20.

As illustrated in FIG. 1, the substrate processing device 100 of processing a glass substrate for a liquid crystal display device includes treatment tanks. In the substrate processing device 100, the substrate 20 having a plate shape is introduced into a tank from the upstream side in the transferring direction while an alignment treatment surface 20A (a surface that has been subjected to the rubbing treatment) facing upward and the substrate 20 being in a horizontal state. The substrate 20 is transferred from the upstream side to the downstream side in the transferring direction by a transferring device 15, which will be described next, while alongside direction thereof being along the X-axis direction and a short side direction thereof being along the Y-axis direction.

As illustrated in FIG. 1, the substrate processing device 100 includes four treatment tanks including a film forming tank 11, a replacement tank 12, a cleaning tank 13, and a drying tank 14 in this order from the upstream side (the left side). The substrate processing device 100 includes the transferring device 15. The transferring device 15 includes transferring rollers 16 that transfer the substrate 20 with a driving source in the transferring direction (the X-axis direction). The substrate 20 is intermittently supported by the transferring rollers 16 that are contacted with a plate surface (a lower surface) of the substrate 20 opposite from the alignment treatment surface 20A. Thus, the substrate 20 is transferred sequentially through each of the treatment tanks in the transferring direction by the transferring device 15 and is subjected to respective treatment in each treatment tank. In this embodiment, the substrate 20 has a size from G4.5 to G6 and the transferring speed is 1.5 m/minute to 3.5 m/minute.

In the film forming tank 11, after the rubbing treatment and before the cleaning with water, a thin film of isopropyl alcohol (IPA 21) (an example of pretreatment material) is formed on a surface of the substrate 20, that is, the alignment treatment surface 20A. A film of IPA 21 is disposed as a pretreatment for covering an entire area of a surface of the substrate with pure water 24 (one example of water-based cleaning material) in the replacement tank 12, which will be described later. Within the film forming tank 11, a curtain type shower 17 (an example of a first pretreatment material supply unit) is arranged on an upstream side and a pipe type shower 18 (an example of a second pretreatment material supply unit) is arranged on a downstream side with respect to the transferring direction. IPA 21 is supplied to the alignment treatment surface 20A by the two kinds of showers and IPA 21 flows in the transferring direction of the substrate 20.

The curtain type shower 17 is connected to a pipe extending from an IPA storing tank and extends in a direction that is along the alignment treatment surface 20A (an X-Y plane surface) of the substrate 20 and perpendicular to the transferring direction (the Y-axis direction). The curtain type shower 17 has thin and long slits on a lower edge surface and IPA 21 is ejected through the slits in a curtain form. The slits are formed such that IPA 21 is ejected to the alignment treatment surface 20A (the X-Y surface) of the substrate 20 at a certain inclination angle θ toward the downstream side in the transferring direction (toward the right side in FIG. 1). Namely, the slits are formed such that IPA 21 is ejected therethrough in a liquid curtain form. The alignment treatment surface 20A of the substrate 20 is covered with an IPA thin film that is formed from IPA 21 ejected obliquely from the curtain type shower 17. The IPA thin film is formed with less unevenness and almost evenly in an entire area of the alignment treatment surface 20A.

The pipe type shower 18 is made of metal and connected to a pipe extending from the IPA storing tank. The pipe type shower 18 has a thin elongated cylindrical shape extending along the alignment treatment surface 20A (the X-Y surface) of the substrate 20 and extending in a direction (the Y-axis direction) perpendicular to the transferring direction. The pipe type shower 18 includes ejecting holes on a surface (a lower surface) opposite the substrate 20. The ejecting holes are arranged in a line at equal intervals. IPA 21 is ejected through the ejecting holes vertically to the substrate 20. In this embodiment, the pipe showers 18 are arranged in a line at a same interval and the ejecting holes 18A have a same hole diameter. Specifically, each of the ejecting holes 18A has a hole diameter from 0.5 mm φ to 1.0 mm φ and a distance between the adjacent ejecting holes 18A is from 10 mm to 15 mm. The ejecting amount ejected through each ejecting hole is from 5 litters/minute to 20 litters/minute. The IPA thin film is formed on the alignment treatment surface 20A of the substrate 20 entirely over a width direction of the substrate 20 just before being discharged from the film forming tank 11. IPA 21 is supplied by the pipe shower 18 again such that the IPA 21 is less likely to be partially dried.

The substrate 20 where IPA 21 is supplied as described before is transferred to an air knife 19 disposed near a discharge port of the film forming tank 11. The air knife 19 is made of SUS. Air 25 (for example clean dry air (CDA)) is ejected from the air knife 19 toward the substrate 20 with certain pressure to remove extra IPA 21. As illustrated in FIG. 1, the air knife 19 extends linearly in the direction that is along the alignment treatment surface 20A (the X-Y plane surface) of the substrate 20 and perpendicular to the transferring direction. The air knife 19 has a slit section 19A on a surface (a lower surface) opposite the substrate 20 so as to have a gap of 0.05 mm to 0.1 mm therebetween. The air 25 is ejected through the slit section 19A uniformly. Ejection pressure is from 0.001 MPa to 0.15 MPa and a total volume of the air 25 ejected through the slit section 19A is about 1000 litters/minute.

The substrate 20 is transferred from the film forming tank 11 to the replacement tank 12 while an entire area of the upper surface thereof being covered with a predetermined film amount of the IPA 21 by the curtain shower 17, the pipe shower 18, and the air knife 19. Each parameter of the curtain shower 17, the pipe shower 18, and the air knife 19 is determined such that the film forming amount of the IPA 21 on the substrate that is just discharged from the film forming tank 11 is in a range from 175 mL/m² to 325 mL/m². The film forming amount of the IPA 21 (an IPA film forming amount) is defined as an IPA liquid amount that is disposed on a unit surface area of the substrate 20 and is obtained by dividing a liquid amount of the IPA 21 disposed on the upper surface of the substrate 20 by an upper surface area of the substrate 20. If the IPA film forming amount is greater than 325 mL/m², the liquid amount of IPA is too much and the IPA 21 is not sufficiently replaced with the pure water 24 in the next replacement tank 12. If the IPA film forming amount is less than 175 mL/m², the liquid amount of IPA is less. If a distance between the air knife 19 and a waterfall shower 22, which will be described later, is reduced corresponding to this situation, the pure water 24 supplied from the waterfall shower 22 hits the air knife 19 that is on the upstream side and this may be another reason of the film forming unevenness of IPA 21.

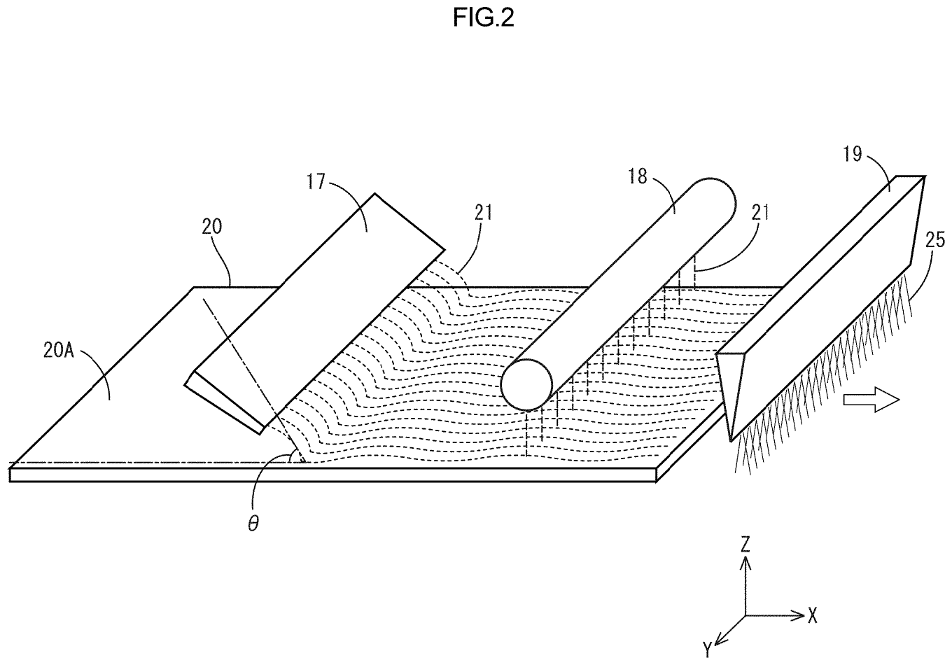

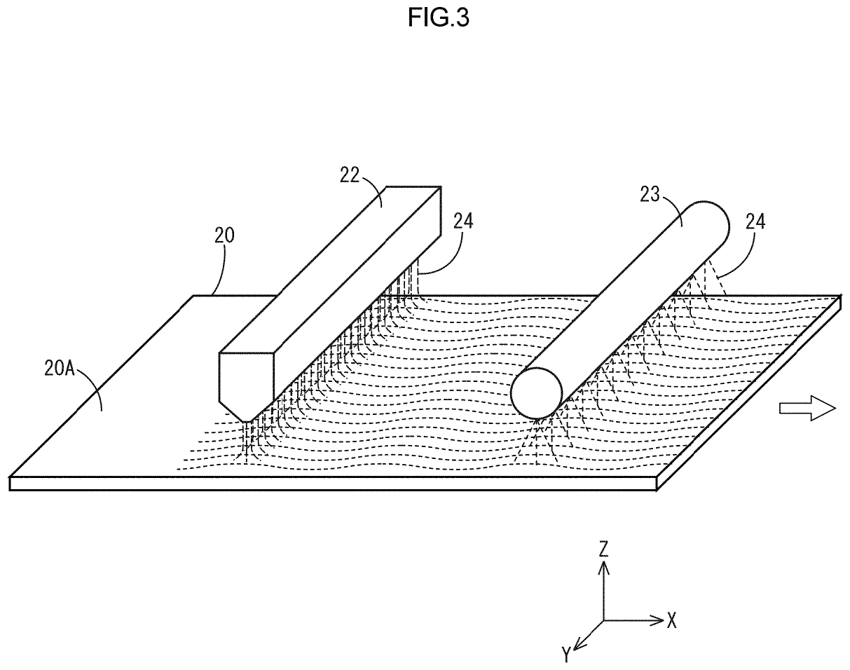

In the replacement tank 12, a film of the IPA 21 disposed on the substrate 20 is replaced with the pure water 24 and the surface (the alignment treatment surface 20A) of the substrate 20 is covered with the pure water 24 uniformly. As illustrated in FIGS. 2 and 3, the waterfall shower 22 (one example of a first cleaning material supply unit) that is made of SUS and supplies the pure water 24 for the replacement to the surface (the alignment treatment surface 20A) of the substrate 20 having a film of the IPA 21 is arranged on the upstream side within the replacement tank 12. The nozzle showers 23 (one example of a second cleaning material supply unit) made of resin (two rows in this embodiment) are arranged on the downstream side of the waterfall shower 22. The nozzle shower 23 includes nozzles through which the pure water 24 for replacement is radially ejected to the substrate 20. The pure water 24 is ejected to the substrate 20 again by the second cleaning device such that the pure water 24 is likely to extend over an entire area of the surface of the substrate 20. The pure water 24 is supplied to the surface of the substrate 20 by the two kinds of cleaning devices and the film of IPA 21 disposed on the substrate 20 is replaced with the pure water 24. The pure water 24 flows in the transferring direction of the substrate 20.

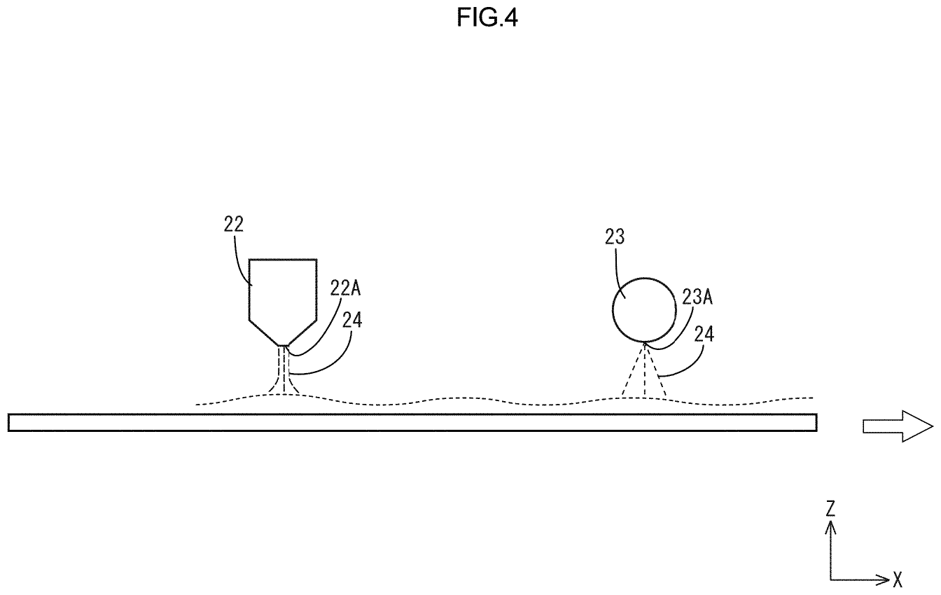

As illustrated in FIGS. 3 and 4, the waterfall shower 22 extends linearly in a direction (the Y direction) that is along the alignment treatment surface 20A (the X-Y plane surface) of the substrate 20 and perpendicular to the transferring direction. The waterfall shower 22 includes a supply section 22A on a surface (a lower surface) opposite the substrate 20. The supply section 22A includes linear slits through which the pure water passes and is along the direction perpendicular to the transferring direction. The pure water 24 is supplied through the supply section 22A in a form of waterfall vertically to the substrate 20. The supply section 22A of the waterfall shower 22 has a gap from 0.5 mm to 5.0 mm along the transferring direction and the total amount of the liquid passing therethrough is from 5 litters/minute to 15 litters/minute.

As illustrated in FIGS. 3 and 4, the nozzle shower 23 includes high pressure discharge holes 23A (twelve holes in the present embodiment) on a surface (a lower surface) opposite the substrate 20 at equal intervals. The pure water 24 is discharged radially toward the substrate 20 with high pressure. The high pressure discharge holes 23A have a same hole diameter. Specifically, the hole diameter of each high pressure discharge hole 23A is 0.3 mm and a distance between adjacent high pressure discharge holes 23A is 60 mm. The discharge pressure is from 4 MPa to 15 MPa and a total amount of discharge liquid amount discharged through each high pressure discharge hole 23A is from 8 litters/minute to 17 litters/minute.

The film of IPA 21 that is disposed on the substrate 20 may be volatilized gradually from a distal end side section thereof with respect to the transferring direction during the transfer and a part of the IPA 21 on the distal end section of the substrate 20 may start to be dried and disappear before the pure water 24 is supplied by the waterfall shower 22, which is the first cleaning material supply unit. Therefore, in the present embodiment, a position of the first cleaning material supply unit with respect to the transferring direction (the position of the waterfall shower 22 with respect to the transferring direction) is adjusted according to the film forming amount of the IPA 21 that is disposed on the substrate 20 in a form of a film. As the film forming amount of the IPA 21 is smaller, the IPA 21 is likely to locally disappear and the film forming unevenness is likely to be caused. Therefore, if the film forming amount of the IPA 21 is small, the position of the waterfall shower 22 is moved toward the upstream side such that the pure water 24 can be supplied before the IPA 21 locally disappears.

The position of the waterfall shower 22 with respect to the transferring direction is adjusted according to the transfer speed of the substrate 20. As the transfer speed is lower, the time required for supplying the pure water 24 after the IPA 21 film is formed on the substrate 20 is longer. Therefore, the IPA 21 is likely to be volatilized and locally disappear and the film forming unevenness is likely to be caused. Therefore, if the transfer speed of the substrate 20 is low, the position of the waterfall shower 22 is moved toward the upstream side such that the pure water 24 is supplied on the upstream side and the IPA 21 is less likely to locally disappear on the substrate 20.

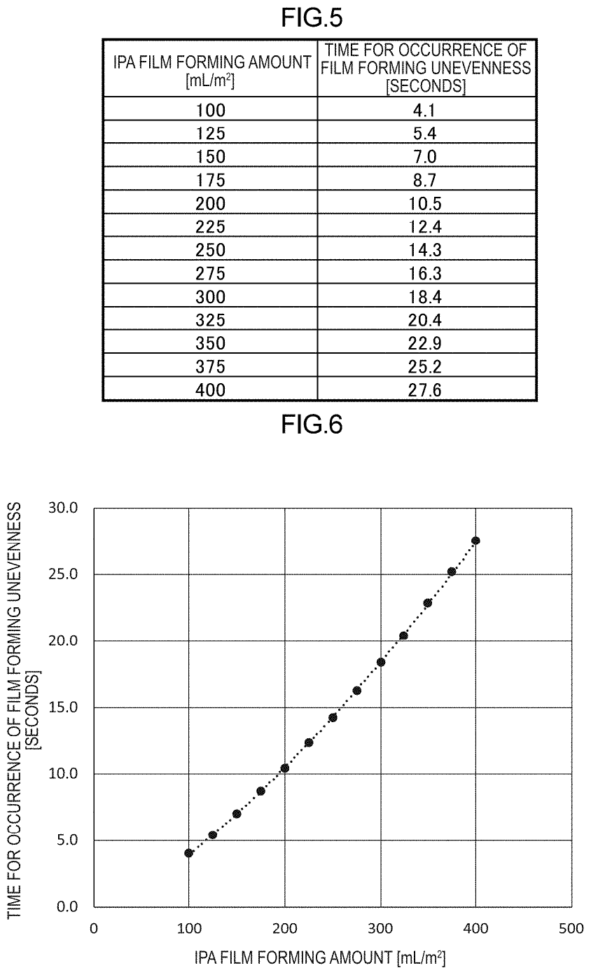

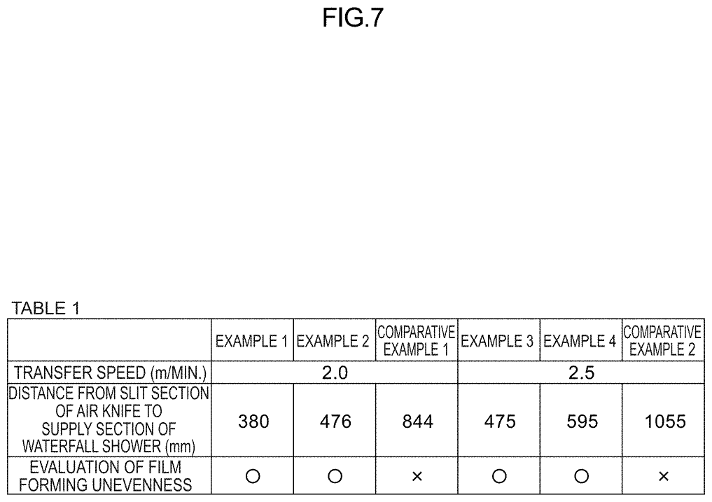

Specifically, if the substrate 20 has a planar surface size of G4.5 (680 mm×880 mm), relation of the IPA film forming amount on the substrate 20 right after the substrate 20 is discharged from the film forming tank 11 and the time taken until the film forming unevenness of the IPA 21 occurs after the substrate 20 passes through the air knife 19 is illustrated in FIGS. 5 and 6. If the IPA film forming amount is about 250 mL/m², the time taken until the film forming unevenness occurs is about 14.3 seconds. Therefore, the distance from the slit section 19A of the air knife 19 to the supply section 22A of the waterfall shower 22 in the transferring direction is adjusted according to the transfer speed such that the transfer time from the slit section 19A of the air knife 19 to the supply section 22A of the waterfall shower 22 is less than about 14.3 seconds. For example, if the transfer speed is 2.5 m/minute, the supply section 22A of the waterfall shower 22 is positioned such that the distance is less than about 595.8 mm. If the transfer speed is 2.0 m/minute, the supply section 22A of the waterfall shower 22 is positioned such that the distance is less than about 476.6 mm.

As described before, the IPA film forming amount is preferably from 175 mL/m² to 325 mL/m². Therefore, the IPA film forming amount is adjusted within the range and the film forming unevenness occurrence time is estimated according to the value of the IPA film forming amount and with reference to FIGS. 5 and 6. The distance between the slit section 19A of the air knife 19 and the supply section 22A of the waterfall shower 22 in the transferring direction is adjusted such that the transfer time from the slit section 19A of the air knife 19 to the supply section 22 of the waterfall shower 22 is less than the estimated film forming unevenness occurrence time. The distance is defined as a distance from a center of the slit section 19A in the transferring direction (the X-axis direction) to a center of the supply section 22 in the transferring direction (the X-axis direction).

As illustrated in FIG. 1, pure water is disposed on the surface of the substrate 20 through the replacement treatment in the replacement tank 12 and the substrate 20 is transferred into the cleaning tank 13 by the transferring device 15. The nozzle showers 23 of the same type as those in the replacement tank 12 are arranged perpendicular to the transferring direction in the cleaning tank 13 (three rows in the present embodiment). The substrate is cleaned with high pressure with the pure water ejected from the nozzle showers 23 and the foreign obstacles on the alignment treatment surface 20A are removed.

The cleaning tank 13 includes the air knife 19, which is a similar type of that in the film forming tank 11, near a discharge port thereof. Extra pure water 24 is removed from the substrate 20 with the air knife 19 and the substrate 20 is transferred to the drying tank 14 by the transferring device 15. In the drying tank 14, extra moisture that remains on the substrate 20 and has not been removed completely with the air knife 19 is removed completely. The substrate 20 is subjected to a high temperature drying treatment and discharged from the substrate processing device 100.

The present embodiment has the configuration described before. Next, operations and advantageous effects of the cleaning process with using the processing device 100 of processing a glass substrate for a liquid crystal display device will be described. In the cleaning process described before, the position of the waterfall shower 22 that supplies the pure water 24 to the substrate 20 first is adjusted according to the film forming amount of the pretreatment material 21 disposed on the substrate 20 in a form of film and the transfer speed of the substrate 20. Accordingly, the pure water 24 is supplied by the waterfall shower 22 before the IPA 21 film disposed on the substrate 20 is volatilized and locally disappears. Since the IPA 21 is less likely to locally disappear and the film forming unevenness is less likely to occur, the cleaning unevenness is less likely to be caused.

### Comparative Experiment 1

To verify the above operations and advantageous effects, Comparative Experiment 1 was performed. In Comparative Experiment 1, Examples 1 to 4 and Comparative Examples 1 to 2 were performed such that the distance from the slit section 19A of the air knife 19 in the film forming tank 11 to the supply section 22A of the waterfall shower 22 in the replacement tank 12 is varied under following conditions. The film forming unevenness was evaluated in each of Examples and Comparative Examples. Experiment results are illustrated in Table 1.

### Conditions

A planar surface size of the substrate: 680 mm×880 mm (G4.5)

A film forming amount of IPA on the substrate passing through the air knife in the film forming tank and transferred to the replacement tank: 150 mL

Transfer speed of the substrate: 2.0 m/minute or 2.5 m/minute.

### Evaluation of Film Forming Unevenness

The produced liquid crystal display panel is checked with an alignment test (the panel was held between two polarizing plates that are perpendicular to each other on the backlight and display quality was checked) and evaluated as o if no unevenness was observed and evaluated as x if unevenness was observed.

Experiment results of Comparative Experiment 1 will be described. The substrates of Comparative Example 1 and Comparative Example 2 were evaluated as x regarding the film forming unevenness as is in Table 1. It is assumed that the IPA was volatilized and locally disappeared while being transferred from the air knife 19 to the waterfall shower 22. On the other hand, in Example 1 to Example 4, the distance between the slit section 19A of the air knife 19 and the supply section 22A of the waterfall shower 22 is adjusted such that the transfer time from the air knife 19 to the waterfall shower 22 is less than about 14.3 seconds that is time required for occurrence of the film forming unevenness. The substrates of Example 1 to Example 4 were evaluated as o regarding the film forming unevenness.

Comparing Examples 1 and 2 and Examples 3 and 4, the distance between the air knife 19 and the waterfall shower 22 is adjusted to be shorter in examples in which the transfer speed of the substrates is low and 2.0 m/minute (Example 1 and Example 2) than in examples in which the transfer speed is high and 2.5 m/minute. It was confirmed that the film forming unevenness was less likely to occur.

In the present embodiment, the transfer speed of the substrate 20 is between 1.5 m/minute to 3.5 m/minute. If the transfer speed of the substrate 20 is less than 1.5 m/minute, the time required for the cleaning process becomes too long and productivity is lowered. If the transfer speed is more than 3.5 m/minute, the cleaning power for cleaning the substrate 20 is lowered. The transfer speed is set between 1.5 m/minute to 3.5 m/minute such that the cleaning power can be maintained and the cleaning treatment can be performed with good productivity.

### Other Embodiments

The present technology described herein is not limited to the embodiments described in the above sections and the drawings. For example, the following embodiments may be included in a technical scope.

(1) In the above embodiment, IPA is used as the pretreatment material and pure water is used as the water-based cleaning material. However, the pretreatment material and the water-based cleaning material may not be limited to the above described examples and other materials may be used.

(2) In the above embodiment, the waterfall shower is used as the first cleaning material supply unit and the nozzle shower is used as the second cleaning material supply unit. Other types of supply units may be used and a curtain shower may be used as the first cleaning material supply unit and a high-pressure spray shower may be used as the second cleaning material supply unit. Further, the number of showers may be altered as appropriate.

(3) In the above embodiment, the curtain shower is used as the first pretreatment material supply unit and the pipe shower is used as the second pretreatment material supply unit. However, it is not limited thereto and the number of showers may be altered as appropriate.

(4) In the above embodiment, the pipe shower and the nozzle shower have the supply holes (the discharge holes, the high pressure discharge holes) that have the same hole diameter and are arranged linearly at equal intervals. However, the intervals between the supply holes (the discharge holes, the high pressure discharge holes) and the hole diameter of the supply holes may be different partially or entirely and the number of rows may be altered as appropriate.

(5) The waterfall shower, the curtain shower, the pipe shower, and the nozzle shower may not be arranged along a direction perpendicular to the transferring direction. For example, the shower may be formed in a V-shape such that a middle section thereof in a width direction is disposed on the downstream side in the transferring direction and two end sections thereof are disposed on the upstream side.

(6) In the above embodiment, the substrate processing device includes one cleaning tank; however, the number of the cleaning tanks is not limited. The cleaning method in each cleaning tank is not necessarily made with a nozzle shower but may be made selectively with a ultrasonic shower, bubble jetting, cavitation jetting, high-pressure spray shower, and a two-fluid type according to a desired effect of removal of foreign obstacles.

(7) In the above embodiment, separate four processing tanks are provided; however, one tank may be divided into cleaning tank sections to provide cleaning tanks.

(8) In the above embodiment, the transferring direction is a long-side direction of the substrate; however, the transferring direction may be a short-side direction.

(9) In the above embodiment, the size of the substrate 20 is from G4.5 to G6; however, substrates of other sizes may be included in the technical scope.

1. A method of producing a glass substrate for a liquid crystal display device including a cleaning process of cleaning a substrate after performing a rubbing treatment on the substrate to align liquid crystal molecules, wherein
in the cleaning process, a position of a first cleaning material supply unit that supplies water-based cleaning material to the substrate on which a film of pretreatment material is disposed and that is transferred in a transferring direction is adjusted according to a film forming amount of the pretreatment material disposed on the substrate and transfer speed of the substrate.

2. The method of producing a glass substrate for a liquid crystal display device according to claim 1, wherein
an air knife is arranged in an upstream side of the first cleaning material supply unit with respect to the transferring direction and has a slit section through which air is ejected to the substrate on which the film of the pretreatment material is disposed, and
a distance from the air knife to the first cleaning material supply unit in the transferring direction is adjusted according to a film forming amount of the pretreatment material of the film disposed on the substrate and the transfer speed of the substrate.

3. The method of producing a glass substrate for a liquid crystal display device according to claim 1, wherein
the first cleaning material supply unit is a waterfall shower that supplies the water-based cleaning material vertically to the substrate and extends in a direction perpendicular to the transferring direction, and
a position of the waterfall shower with respect to the transferring direction is adjusted according to a film forming amount of the pretreatment material on the substrate and the transfer speed of the substrate.

4. The method of producing a glass substrate for a liquid crystal display device according to claim 2, wherein
the first cleaning material supply unit is a waterfall shower that has a supply section that supplies the water-based cleaning material vertically to the substrate and extends in a direction perpendicular to the transferring direction, and
a distance from the slit section of the air knife to the supply section of the waterfall shower in the transferring direction is adjusted according to a film forming amount of the pretreatment material of the film disposed on the substrate and the transfer speed of the substrate.

5. The method of producing a glass substrate for a liquid crystal display device according to claim 1, wherein the transfer speed of the substrate is from 1.5 m/minute to 3.5 m/minute.

6. The method of producing a glass substrate for a liquid crystal display device according to claim 1, wherein the film forming amount of the pretreatment material on the substrate is from 175 mL/m² to 325 mL/m².

7. The method of producing a glass substrate for a liquid crystal display device according to claim 1, wherein the water-based cleaning material is supplied to the substrate again by a second cleaning material supply unit that is arranged on a downstream side of the first cleaning material supply device with respect to the transferring direction.
